(19) United States
(12) Patent Application Publication
(10) Pub. No.: US 2004/0129372 A1
(43) Pub. Date: Jul. 8, 2004

(54) Separating method for recycling foil-laminated material

(76) Inventors: Chao-Kuo Huang, Taichung Hsien (TW); Chung-Hsing Shao, Taichung Hsien (TW)

Correspondence Address: Jackson Walker L.L.P., Suite 2100, 112 E. Pecan Street, San Antonio, TX, 78205, US

(21) Appl. No.: 10/649,987

(22) Filed: Aug. 27, 2003

(30) Foreign Application Priority Data
Sep. 12, 2002 (TW) 091120815

(51) Int. Cl. B32B 35/00; B32B 1/00

(52) U.S. Cl. 156/94; 156/344

(57) ABSTRACT

A separating method for recycling foil-laminated material basically uses an acid solution containing nitric acid as a stripping agent to soak foil-laminated material. The stripping agent permeates into the foil-laminated material to dissolve alumina at interfaces to separate a foil layer and a plastic layer or a paper layer. Whereby, useful materials of the foil layer, the plastic layer, and the paper layer in the foil-laminated material are separated completely for a subsequent recycling process.

### BACKGROUND OF THE INVENTION

1. Field of the Invention

The present invention relates to a separating method for recycling foil-laminated material such as foil-plastic or foil-plastic-paper packaging, and more particularly to a separating method that uses a nitric acid solution to soak and peel different material layers of the foil-laminated material apart in preparation for a recycling process.

2. Description of Related Art

Foil-laminated material such as foil packaging is widely used and is basically composed of a foil layer, a plastic membrane layer and selectively a paper layer combined together to achieve the foil packaging. The foil packaging is mostly applied to foods, medicines, chemicals, beverages and other objects that can not be exposed to sunlight, because the foil layer has excellent preservative efficiency such as photo-resisting capability and thermal-preserving capability to contain perishable contents. Meanwhile, the foil packaging has low manufacturing cost and is produced in considerable quantities. Take “paper cartons” as an example, which is composed of an outer layer, a middle layer, and an inner layer. The outer layer of the paper carton is a paper layer printed with product patterns or trademarks. The middle layer is a foil layer having a photo-resisting capability and thermal-preserving capability. The inner layer is a polyethylene plastic membrane to isolate the beverage from contact with the foil layer. Interfaces between two layers are laminated by high-frequency combination or thermal pressing combination to combine two layers together, herein material of the interfaces on the foil layer is changed from aluminum to stable alumina (Al₂O₃), to achieve the foil packaging.

Since the combination strength of the foil packaging is excellent, it is difficult to separate the foil layer containing aluminum from the plastic membrane and the paper layer during recycling processes. Because the foil packaging is widely used in modern life, predictably, considerable quantities of waste foil packaging will be produced and cause environment problems and extreme waste of usable resources if the materials of the foil packaging can not be reused.

Because of the difficulty of separating the foil layer, most of the foil packaging is treated as waste after use. One conventional separating and recycling method for foil-laminated material is a physical treatment that pulverizes the foil-laminated material into pieces to separate the foil layer from the plastic membrane or paper layer by the tearing force. However, using this conventional separating method not only has troublesome processes and high operating cost, but also has low recycling purity and low recycling value of the material. Furthermore, the separation is incomplete due to some foil layer residue being on the plastic membrane (or the paper layer) or some plastic membrane (or the paper layer) residue being left on the foil layer.

To overcome the shortcomings, the present invention tends to provide an improved separating method for recycling foil-laminated material to mitigate and/or obviate the aforementioned problems of the conventional separating method for recycling useful materials from the foil-laminated material.

### SUMMARY OF THE INVENTION

The main objective of the invention is to provide a separating method for recycling foil-laminated material wherein a chemical treatment uses nitric acid solution to permeate the plastic layer or the paper layer to dissolve the alumina layer, whereby the foil layer, plastic layer, and the paper layer of the foil-laminated material are completely separated for efficient recycling.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a separating method for recycling foil-laminated material in accordance with the present invention; and

FIG. 2 is a schematic equipment flowchart of the separating method for recycling foil-laminated material in accordance with FIG. 1.

### DETAILED DESCRIPTION OF PREFERRED EMBODIMENT

A separating method for recycling foil-laminated material in accordance with the present invention comprises the following acts of: soaking waste foil-laminated material in a stripping agent until different layers of the foil-laminated material are separated; straining the stripping agent from the separated layers of the foil-laminated material; neutralizing the stripping agent remaining on the separated layers; cleaning the separated layers; drying the separated layers; and classifying the separating layers for a subsequent recycling process.

The foil-laminated material is composed of a foil layer laminated with at least one permeable-layer such as a plastic layer or a paper layer by forming alumina at interfaces. In this method, the stripping agent containing at least nitric acid is used to permeate the plastic layer or the paper layer to dissolve alumina at interfaces to divide the foil-laminated material into a separated foil layer and a separated plastic layer or a separated paper layer. Selectively, the foil-laminated material can be a foil packaging, a cable covering, a plastic tube with foil laminations and so on. Detail descriptions and operational conditions in this method are illustrated as following:

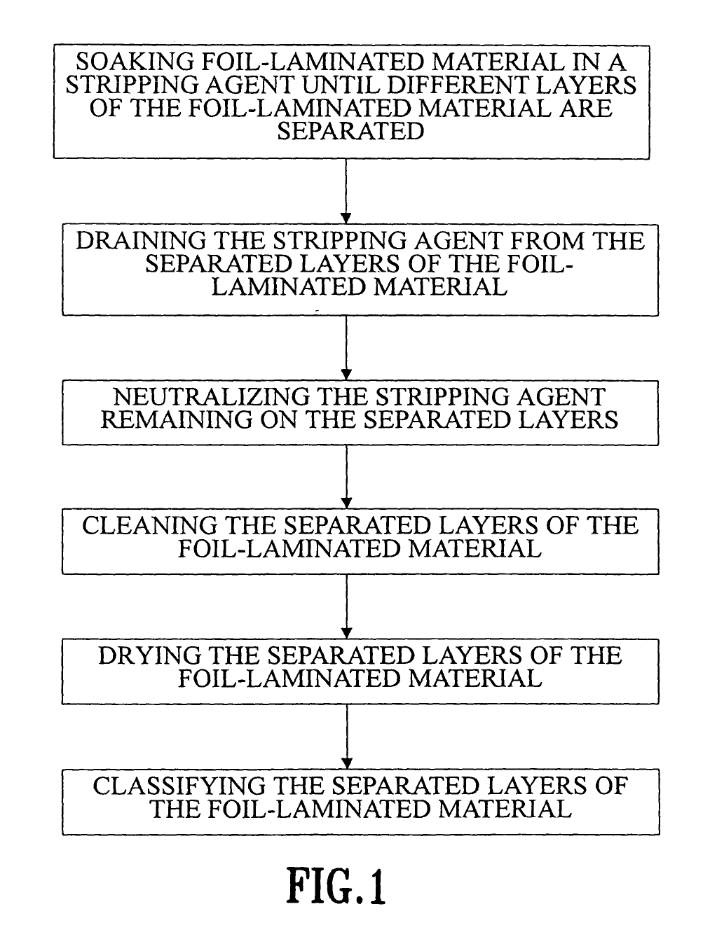

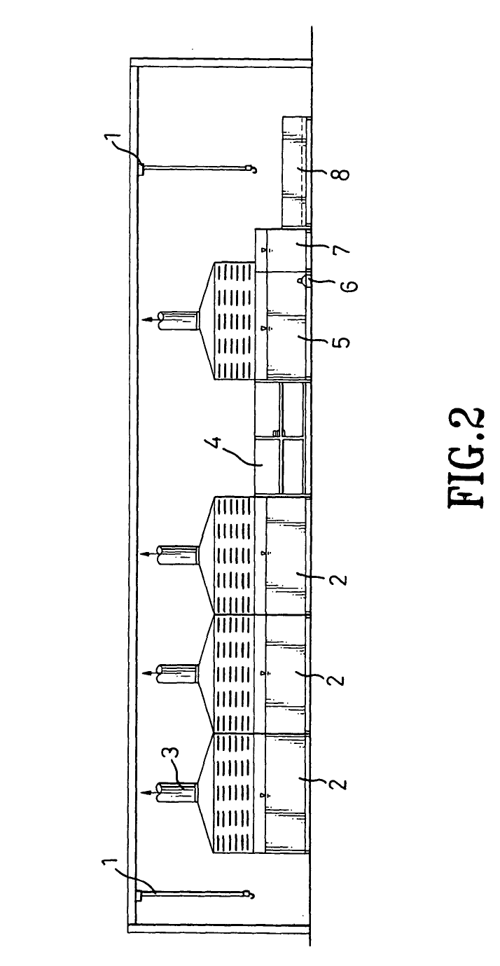

With reference to FIGS. 1 and 2, the separating method for recycling foil-laminated material comprises the following operational acts in practice.

The foil-laminated material waste is collected in a basket (not shown) hooked under a hoisting machine (1) and lowered to soak in a stripping tank (2) containing a stripping agent. The stripping agent is an acid solution containing nitric acid and has 15˜68% concentration of nitric acid. The stripping agent selectively adds acetic acid and phosphoric acid to make the stripping agent have more stripping efficiency. Optionally, a heating process is carried out within a temperature range of 40˜70° C. when soaking the foil-laminated material to accelerate stripping speed. An inducing pipe (3) is mounted on a top of the stripping tank (2) to collect toxic gases generated during the stripping process and to transport to an exhaust gas treating equipment to process those gases until they are transformed for safe emission.

After separating different layers of the foil-laminated material, the hoisting machine (1) brings the basket with the separated layers of foil layers, plastic layers, and paper layers to a solution-collecting tank (4). In the solution-collecting tank (4), the stripping agent remaining on surfaces of each separated layer is drained out into the solution-collecting tanks (4) to keep the separated layers damp but not wet.

Then, the basket with the solution-strained separated layers of foil layers, plastic layers, and paper layers of the foil-laminated material moves to a washing tank (5). In the washing tank (5), a high-pressure washer (6) is attached inside the washing tank (5) to wash off with water most of the stripping agent remaining on surfaces of the separated layers.

After washing, the washed separated layers of foil, plastic and paper of the foil-laminated material move to an ultrasonic neutralizing tank (7) accommodating basic solution containing sodium hydroxide. The basic solution of sodium hydroxide neutralizes the stripping agent of nitric acid to avoid causing injury to operators who handle separated layers in subsequent operations. Additionally, the ultrasonic vibration in the ultrasonic neutralizing tank (7) cleans impurities from the surfaces of the separated layers to make the recycling of the foil-laminated material further convenient.

Then, the cleaned and separated layers of different materials of the foil-laminated material are moved to an unloading stage (8) to be air-dried and classified according to different materials for recycling. Each recycled material is kept separate and is a useful material since each recycled material has high purity.

In the separating method for recycling foil-laminated material, the nitric acid in the stripping agent permeates the plastic layer (made mostly of polyethylene) and into the interfaces between the foil layer and the plastic layer to dissolve the alumina (Al₂O₃) and to separate the layers. With regard to the interfaces between the foil layer and the paper layer, the nitric acid also permeates the paper layer to dissolve the alumina to separate the foil layer and the paper layer.

Operational conditions of the present invention are that the concentration of the stripping agent is 15˜68% and the heating temperature is 40˜70° C. The concentration of the stripping agent and the heating temperature are determined according to thickness of the plastic layer. Practically, when the concentration of the stripping agent is 68% and the heating temperature is 60° C., a soaking time in the stripping agent for the foil-laminated material is 40-minute. When the concentration of the stripping agent is 34% and the heating temperature is 65° C., the soaking time for the foil-laminated material in the stripping agent is 60-minute.

If the stripping act is carried out without heating, the operational conditions are: when the stripping agent is 30˜34%, the soaking time is 7-hour; when the stripping agent is 20˜30%, the soaking time is 15-hour. Thereby, the heating act accelerates the stripping of the layers of the foil-laminated material to shorten the soaking time.

The separating method for recycling foil-laminated material in the present invention has the advantages that the nitric acid permeates the permeable layers to reach interfaces of the foil layer and to dissolve the alumina. Whereby, the layers of the foil-laminated material are completely separated to achieve the purpose of recycling high purity materials. Meanwhile, the method in the present invention uses heating to accelerate the stripping reaction and to shorten the soaking time. Therefore, this method is suitable for treating foil-laminated material in a large quantity batches and has no need to consume electricity or other energy in step of separating layers of the foil-laminated material to have low operation cost.

Even though numerous characteristics and advantages of the present invention have been set forth in the foregoing description, together with details of the function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A separating method for recycling foil-laminated material composed of a foil layer laminated with at least one permeable layer by forming alumina at interfaces, and the method comprising acts of:
soaking foil-laminated material in a stripping agent, wherein the stripping agent is an acid solution containing nitric acid to permeate the at least one permeable layer to dissolve alumina at interfaces to divide the foil-laminated material into a separated foil layer and at least one separated permeable layer;
cleaning the separated foil layer and the at least one separated permeable layer;
drying the separated foil layer and the at least one separated layer; and
classifying the separated foil layer, the at least one permeable layer for subsequent recycling processes.

2. The separating method as claimed in claim 1, wherein the separating method further comprises an act after soaking, wherein the act is:
draining the stripping agent from surfaces of the separated foil layer and the at least one permeable layer to remove most of stripping agent;
whereafter, the at least one permeable layer and the separated foil layer are cleaned with water and then applied with the act of drying.

3. The method as claimed in claim 1, wherein the separating method further comprises an act after cleaning, wherein the act is:
neutralizing the stripping agent with a basic solution;
whereafter, the separated foil layer and the at least one permeable are applied with the act of drying.

4. The method as claimed in claim 1, wherein a heating act is carried out at the same time as the soaking act to accelerate speed of dissolving the alumina.

5. The method as claimed in claim 1, wherein the at least one permeable layer is one layer made of a plastic layer.

6. The method as claimed in claim 4, wherein the at least one permeable layer are two layers respectively made of a plastic layer and a paper layer, wherein the foil layer is laminated between the plastic layer and the paper layer;
the stripping agent is 15˜68% nitric acid; and
wherein a heating temperature range of the heating act is 40˜70° C.

7. The method as claimed in claim 6, wherein the stripping agent is 68% nitric acid;
the heating temperature of the heating act is 60° C.; and
a soaking time is 40-minute.

8. The method as claimed in claim 6, wherein the stripping agent is 34% nitric acid;
the heating temperature of the heating act is 65° C.; and
a soaking time is 60-minute.

9. The method as claimed in claim 1, wherein the stripping agent further comprises acids selected from the group of acetic acid and phosphoric acid.

10. The method as claimed in claim 1, wherein the stripping agent is 30˜34% nitric acid; and
a soaking time of the soaking act is 7-hour.
